(19) United States
(12) Patent Application Publication
(10) Pub. No.: US 2010/0062297 A1
(43) Pub. Date: Mar. 11, 2010

(54) INSULATING DEVICE AND TENSIONING DEVICE FOR A HIGH TEMPERATURE FUEL CELL SYSTEM COMPONENT

(75) Inventors: Jens Hafemeister, Neustrelitz (DE); Matthias Boltze, Wulkenzin (Ot Neuendorf) (DE)

Correspondence Address: FITCH EVEN TABIN & FLANNERY, 120 SOUTH LASALLE STREET, SUITE 1600, CHICAGO, IL, 60603-3406, US

(73) Assignee: Enerday GMBH, Neubrandenburg (DE)

(21) Appl. No.: 12/516,540

(22) PCT Filed: Nov. 7, 2007
(86) PCT No.: PCT/DE2007/002007

§ 371 Date: May 27, 2009

(30) Foreign Application Priority Data
Dec. 21, 2006 (DE) 102006060809.7

(51) Int. Cl. H01M 8/18; H01M 2/00

(52) U.S. Cl. 429/19; 429/34

(57) ABSTRACT

The invention relates to a device comprising a thermally insulating receptacle and, arranged in the receptacle, at least one high-temperature fuel cell system component enclosed by at least one insulating layer of a first material, a clamping means acting on the insulating layer. In accordance with the invention it is provided for that the clamping means comprises, supported by a receptacle housing and acting on the insulating layer, one or more plate-shaped elements made of a second material which is elastically deformable at a contact pressure, at which the first material is not deformable.

The invention relates to a device comprising a thermally insulating receptacle and, arranged in the receptacle, at least one high-temperature fuel cell system component enclosed by at least one insulating layer of a first material, a clamping means acting on the insulating layer.

It is known, for example, in conjunction with solid oxide fuel cell (SOFC) systems to produce the fuel cell stack under a defined clamping force. The clamping force employed during production, storage and installation of the fuel cell stack in the system intended therefor may be particularly a temporary clamping force which can be removed once a final clamping force has been provided. Applying this final clamping force can be done as it reads from the German patent DE 103 08 382 B3 teaching the final clamping force to be provided external to an insulant enclosing the high-temperature fuel cell stack, more particularly in the form of a clamping frame and tension rods. The drawback of such a clamping system is its weight whilst being relatively bulky and costly. In addition to this, the problem may occur that the high-temperature insulation shrinks when subjected to pressure and high temperatures, resulting in a deterioration of the insulation properties, for, the shrinkage in the insulant can result in fissures. This problem may also be relevant when several components of a fuel cell system are accommodated in common in a hot-box.

It is an object of the invention to sophisticate generic devices particularly as regards clamping and insulating high-temperature fuel cell stacks so that the aforementioned problems are avoided or at least alleviated.

This object is achieved by the features of claim 1.

Advantageous aspects and further embodiments of the invention read from the dependent claims.

The device in accordance with the invention is a sophistication over generic prior art in that the clamping means comprises, supported by a receptacle housing and acting on the insulating layer, one or more plate-shaped elements made of a second material which is elastically deformable at a contact pressure, at which the first material is not deformable. The flexibility of the second material as compared to the first material forming the insulating layer now makes it possible to counteract fissures occurring, caused by shrinkage of the insulant as may occur under pressure and high temperatures. This thus now provides for a durable insulation of the high-temperature fuel cell system component with no restrictions. It is furthermore possible to exert a defined clamping force on the high-temperature fuel cell system component via a predefined compression of the second material.

In the scope of the invention it is now possible, in particular, that at least one of the following high-temperature fuel cell system components is arranged in the receptacle: high-temperature fuel cell stack, reformer, burner, controller. In this arrangement it is particularly of advantage when at least the high-temperature fuel cell stack is accommodated in the receptacle since this needs to be both insulated and clamped during operation. In addition, or as an alternative thereto, it is, however, just as possible to arrange a reformer used for generating the combustion gas fully or partly within the insulation, in which case the clamping forces can serve to locate the reformer. The same applies to a burner, for example, an afterburner. In conjunction with accommodating a controller it may be of advantage to arrange this external to the insulating layer so that the permissible operation temperature of the electronic components is not exceeded. In this case it is both possible to arrange the controller between the insulating layer and the second material as well as between the second material and the receptacle housing. If need be, apertures may be provided in the first and/or second material for mounting at least a portion of the controller.

It is especially as regards accommodating the high-temperature fuel cell stack that it is considered to be particularly of advantage that the insulating layer comprises an insulating layer cover, movable in a preferred expansion direction of the high-temperature fuel cell system component. In the case of a high-temperature fuel cell stack the preferred direction of expansion thereof is in the stacking direction. In this case the insulating layer may be configured to advantage cup-shaped so that the insulating layer cover is located within the cup in contact with its inner circumference so that the insulating layer cover can move up and down with a change in level of the high-temperature fuel cell stack within the cup-shaped portion of the insulating layer.

A likewise preferred further embodiment of the device in accordance with the invention provides for at least one aperture through which one or more supply lines of the high-temperature fuel cell system component are guided. With reference to a high-temperature fuel cell stack the supply lines may be, for example, the anode gas feeder or exhaust conduits as well as the cathode gas feeder or exhaust conduits, whereas where a reformer is concerned fuel and air conduits as well as at least one fuel gas exhaust conduit come into consideration. In the case of a burner it may be necessary to provide a fuel feeder and also to exhaust the gases from the device.

In conjunction with that as described above it is considered to be particularly of advantage to provide for the at least one aperture to be located on the side of the insulating layer opposite the insulating layer cover. For example, in the case of a high-temperature fuel cell stack the supply lines can be arranged on a base plate of the high-temperature fuel cell stack so that the preferred direction of expansion extends perpendicular to the base plate.

In the scope of the invention it is considered to be particularly of advantage when the first material is a microporous insulant. As an alternative it would just as feasible to use Al₂O₃ based high-temperature insulating plates.

It is furthermore considered to be particularly of advantage that the first material does not conform when the contact pressure is less than 1 N/mm² in thus making it possible to fully communicate the necessary clamping forces generated by the second material via the first material to the high-temperature fuel cell system components.

In preferred aspects of the invention it is provided for that the second material comprises caoutchouc, particularly a cellular caoutchouc material, or polyurethane, particularly foamed polyurethane.

It is especially in this case that it is furthermore considered to be of advantage that the second material has a density in the range 110 g/dm³ to 150 g/dm³, good results having been attained, for example, with cellular caoutchouc material having a density of approximately 130 g/dm³.

The invention now makes it possible, for example, to insulate a fuel cell stack as it reads from German patent DE 103 08 382 B3 with a microporous insulant. The insulation topping the fuel cell stack is preferably configured shiftable to accommodate any elongation of the fuel cell stack. Furthermore, the insulation is packaged in cellular caoutchouc (density for example 130 g/dm³) or foamed polyurethane. The cellular caoutchouc or foamed polyurethane is subjected to a predefined clamping force with the aid of the receptacle housing, particularly of sheet metal, welded at the sides respectively top and bottom.

An example embodiment of the invention will now be detailled by way of example with reference to the corresponding drawings in which:

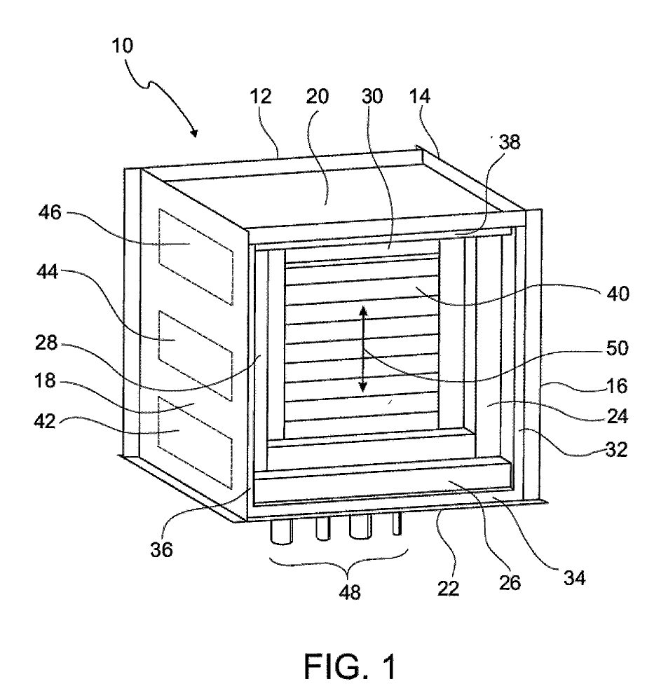

FIG. 1 is a diagrammatic view in perspective of one embodiment of the device in accordance with the invention, the front side of which is partly cut away to illustrate the structure of the device;

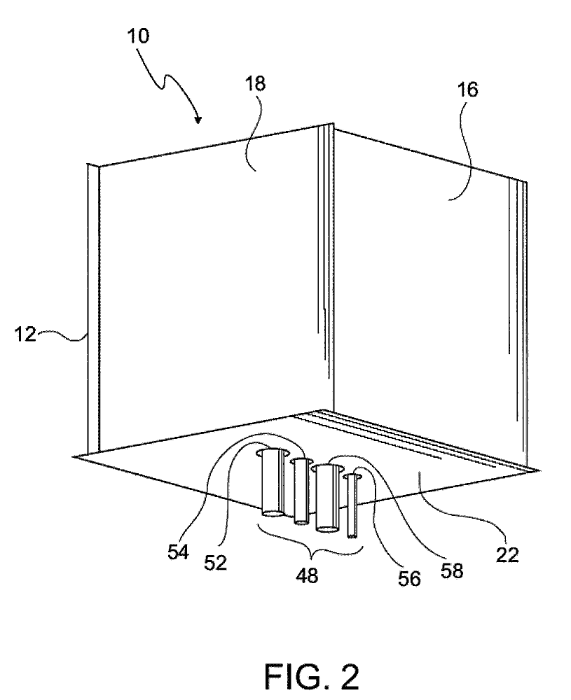

FIG. 2 is a diagrammatic view in perspective of the device as shown in FIG. 1 showing particularly the underside of the device.

Referring now to the figures there is illustrated how the device 10 comprises a thermally insulating receptacle in which at least one high-temperature fuel cell system component is arranged. The receptacle comprises a housing formed by six sheet metal panels 12-22 each welded to the other. The front sheet metal panel 16 is shown partly cut out to illustrate the inner structure of the device 10. Accommodated within the housing 12-22 is a high-temperature fuel cell stack 40, the stacking direction of which is simultaneously the direction of expansion 50. The high-temperature fuel cell stack 40 is connected to supply lines 48 comprising particularly an anode gas feeder and exhaust as well as a cathode gas feeder and exhaust. The supply lines 48 are guided through apertures 52-58 in the lower sheet metal panel 22 outwards. It is just as possible that the device 10 also houses a reformer 42 and/or a burner 44 and/or a controller 46 as is indicated by the corresponding broken line boxes. The high-temperature fuel cell stack 40 is enclosed by an insulating layer 24-30 made of a microporous insulant. This insulating layer 24-30 comprises an insulating layer cover 30 which is free to move up and down in the direction of expansion 50 of the high-temperature fuel cell stack 40 within the insulant otherwise configured cup-shaped. It will be appreciated that the insulant fully encloses the high-temperature fuel cell stack 40, of course, i.e. the front side of the insulant being cut open simply to illustrate the structure of the device 10. The microporous insulant forming the insulating layer 24-30 is designed so that it does not deform when the contact pressure is less than 1 N/mm². This makes it possible to clamp the high-temperature fuel cell stack predefined with the aid of plate-shaped elements 32-38 of a second material at a contact pressure at which the microporous insulant forming the insulating layer 24-30 is not deformable. In the case as shown the second material comprises cellular caoutchouc having a density of 130 g/dm³. The cellular caoutchouc supported by the receptacle housing 12-22 not only promotes the force necessary for clamping the high-temperature fuel cell stack 40 in the direction of expansion 50, it also acts on the insulating layer 24-30 so that fissures due to shrinkage of the material forming the insulating layer 24-30 are safely avoided. It will be appreciated that in the lower portion 26 of the insulating layer and in the lower panel 34 apertures need to be provided oriented with the apertures 52-58, ideally the insulant and preferably also the corresponding cellular caoutchouc plate 34 being in intimate contact with the supply lines 48 to avoid fissures in the insulation in this region.

It is understood that the features of the invention as disclosed in the above description, in the drawings and as claimed may be essential to achieving the invention both by themselves or in any combination.

LIST OF REFERENCE NUMERALS

10 device

12 housing sheet metal panel

14 housing sheet metal panel

16 housing sheet metal panel

18 housing sheet metal panel

20 housing sheet metal panel

22 housing sheet metal panel

24 insulating layer wall

26 insulating layer wall

28 insulating layer wall

30 insulating layer cover

32 plate-shaped element

34 plate-shaped element

36 plate-shaped element

38 plate-shaped element

40 high-temperature fuel cell stack

42 reformer

44 burner

46 controller

48 supply lines

50 direction of expansion

52 aperture

54 aperture

56 aperture

58 aperture

1. A device, comprising: a thermally insulating receptacle and, arranged in the receptacle, at least one high-temperature fuel cell system component enclosed by at least one insulating layer of a first material, a clamping means acting on the insulating layer, wherein the clamping means comprises, supported by a receptacle housing and acting on the insulating layer, one or more plate-shaped elements made of a second material which is elastically deformable at a contact pressure, at which the first material is not deformable.

2. The device of claim 1, wherein at least one of the following high-temperature fuel cell system components is arranged in the receptacle: high-temperature fuel cell stack, reformer, burner, controller.

3. The device of claim 1, wherein the insulating layer comprises an insulating layer cover, movable in a preferred expansion direction of the high-temperature fuel cell system component.

4. The device of claim 1, wherein at least one aperture through which one or more supply lines of the high-temperature fuel cell system component are guided.

5. The device of claims 3, wherein at least one aperture is provided on the side of the insulating layer opposite the insulating layer cover.

6. The device of claim 1, wherein the first material is a microporous insulant.

7. The device of claim 1, wherein the first material does not deform when the contact pressure is less than 1 N/mm².

8. The device of claim 1, wherein the second material comprises caoutchouc, particularly a cellular caoutchouc material, or polyurethane, particularly foamed polyurethane.

9. The device of claim 1, wherein the second material has a density in the range 110 g/dm³ to 150 g/dm³.
